(19) United States
(12) Patent Application Publication
(10) Pub. No.: US 2026/0365431 A1
(43) Pub. Date: Nov. 19, 2026

(54) STORAGE SYSTEM

(71) Applicant: TOYOTA JIDOSHA KABUSHIKI KAISHA, Aichi-ken (JP)

(72) Inventor: Thomas STEWART, Tokyo-to (JP)

(73) Assignee: TOYOTA JIDOSHA KABUSHIKI KAISHA, Aichi-ken (JP)

(21) Appl. No.: 19/676,806

(22) Filed: May 14, 2026

(30) Foreign Application Priority Data
May 15, 2025 (JP) 2025-081929

(51) Int. Cl. B65G 1/137; B65G 1/04

(52) U.S. Cl. CPC B65G 1/1371; B65G 1/0421; B65G 2201/0235; B65G 2203/0216; B65G 2203/041

(57) ABSTRACT

A storage system which facilitates the management of stored items is provided. A storage system according to the present disclosure includes: a shelf including a plurality of storage sections into which a plurality of respective containers are able to be incorporated; a camera configured to capture a captured image of each of the containers; a conveyance part configured to convey each of the containers among the plurality of storage sections; a generation unit configured to generate an inventory of a plurality of items stored in the plurality of the containers based on the captured images; and a search unit configured to search for the container in which the item corresponding to text information input by a user is stored based on the inventory.

### CROSS REFERENCE TO RELATED APPLICATIONS

This application is based upon and claims the benefit of priority from Japanese patent application No. 2025-081929, filed on May 15, 2025, the disclosure of which is incorporated herein in its entirety by reference.

### BACKGROUND

The present disclosure relates to a storage system.

Patent Literature 1 discloses a cleaning robot for storing articles received from a user in a storage place.
[Patent Literature 1] Japanese Unexamined Patent Application Publication No. 2007-152443

### SUMMARY

When a plurality of articles are stored in a storage place, there is a problem that a user cannot easily find each of the articles. Further, when a plurality of articles are stored in a storage place, it may be difficult for a user to physically access each of the articles.

The present disclosure has been made in view of the aforementioned circumstances and an object thereof is to provide a storage system which facilitates the management of stored items.

A storage system according to the present disclosure includes:
a shelf including a plurality of storage sections into which a plurality of respective containers are able to be incorporated;
a camera configured to capture a captured image of each of the containers;
a conveyance part configured to convey each of the containers among the plurality of storage sections;
a generation unit configured to generate an inventory of a plurality of items stored in the plurality of the containers based on the captured images; and
a search unit configured to search for the container in which the item corresponding to text information input by a user is stored based on the inventory.

According to the present disclosure, it is possible to provide a storage system which facilitates the management of stored items.

The above and other objects, features and advantages of the present disclosure will become more fully understood from the detailed description given hereinbelow and the accompanying drawings.

### BRIEF DESCRIPTION OF DRAWINGS

FIG. 1 is a perspective view of a storage system according to a first embodiment when viewed from a front side thereof;

FIG. 2 is a perspective view of the storage system according to the first embodiment when viewed from a back side thereof;

FIG. 3 is a block diagram illustrating the storage system according to the first embodiment;

FIG. 4 is a schematic side view of the storage system according to the first embodiment;

FIG. 5 is a schematic diagram illustrating an operation of the storage system according to the first embodiment;

FIG. 6 is a perspective view illustrating a container according to the first embodiment;

FIG. 7 is a schematic diagram illustrating items stored in the container according to the first embodiment;

FIG. 8 is a schematic diagram illustrating item information according to the first embodiment;

FIG. 9 is a schematic diagram illustrating a display screen displayed on a user terminal according to the first embodiment;

FIG. 10 is a schematic diagram illustrating a shelf to which light emitting units are attached according to the first embodiment; and

FIG. 11 is a schematic diagram illustrating an image displayed on a display unit of a user terminal according to the first embodiment.

### DESCRIPTION OF EMBODIMENTS

Specific embodiments to which the present disclosure is applied will be described hereinafter in detail with reference to the drawings. However, the present disclosure is not limited to the following embodiments. Further, for the clarification of the description, the following descriptions and drawings are simplified as appropriate.

### First Embodiment

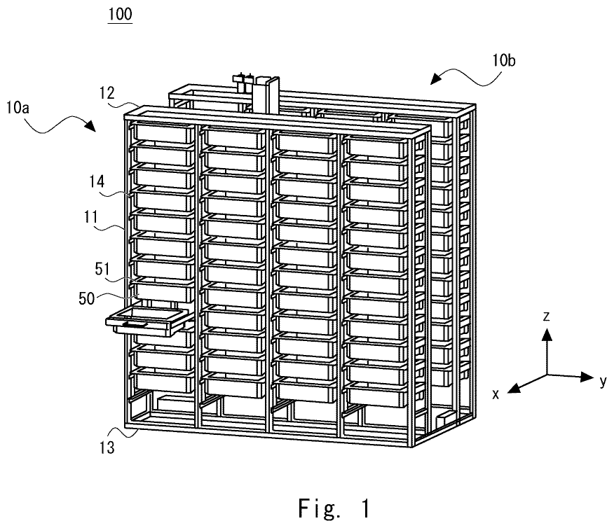

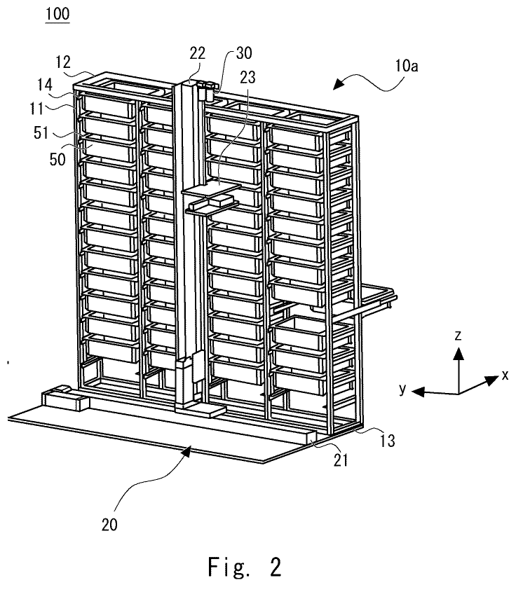

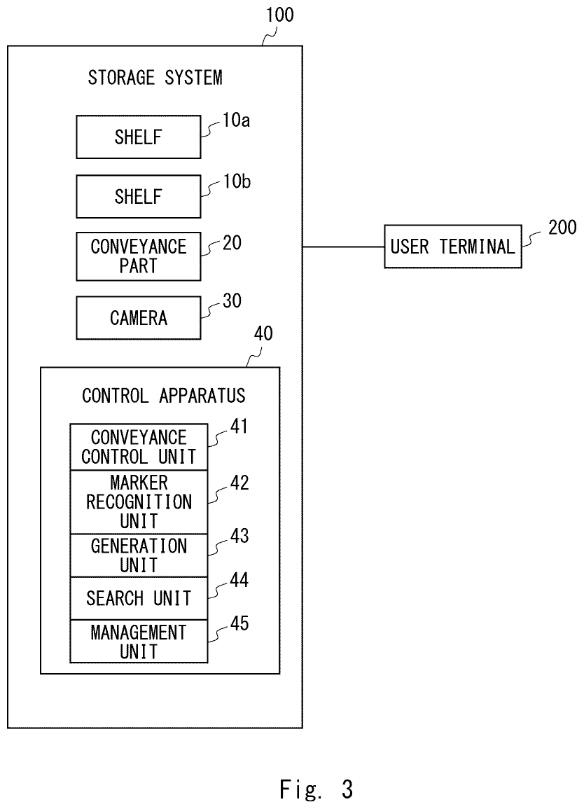

FIG. 1 is a perspective view of a storage system 100 according to a first embodiment when viewed from a front side thereof. FIG. 2 is a perspective view of the storage system 100 according to the first embodiment when viewed from a back side thereof. FIG. 3 is a block diagram illustrating the storage system 100 according to the first embodiment.

In FIG. 2, a shelf 10b of the storage system 100 on the back side thereof is omitted so that the interior of the storage system 100 can be seen. The storage system 100 includes a shelf 10a, the shelf 10b, a conveyance part 20, a camera 30, and a control apparatus 40.

The right-handed xyz orthogonal coordinates shown in FIG. 1 and other drawings are shown only for the sake of convenience to explain positional relations among the components. Normally, the z-axis positive direction is a vertically upward direction, and the xy plane is a horizontal plane, which direction and plane are the same throughout the drawings.

Referring to FIGS. 1 and 2, the shelf 10a is provided on the front side (on the x-axis positive direction side) of the storage system 100. The shelf 10b is provided on the back side (on the x-axis negative direction side) of the storage system 100. Each of the shelf 10a and the shelf 10b may be simply referred to as a shelf 10 when they are not distinguished from each other. Note that the first embodiment may also include a case where the storage system 100 does not include the shelf 10b.

The shelf 10a includes support columns 11, an upper connection frame 12, a lower connection frame 13, and support parts 14. Note that the configuration of the shelf 10b is similar to that of the shelf 10a, and the descriptions of the shelf 10b will thus be omitted. The support columns 11 are arranged in two rows along the y-axis direction. The upper connection frame 12 connects the upper parts of a plurality of the support columns 11 to each other. The lower connection frame 13 connects the lower parts of the plurality of the support columns 11 to each other. The shelf 10a may include side plates installed parallel to the xz plane on the y-axis positive direction side and the y-axis negative direction side. The shelf 10a may include a top plate installed parallel to the xy plane on the z-axis positive direction side. The shelf 10a may include a bottom plate installed parallel to the xy plane on the z-axis negative direction side.

A plurality of the support parts 14 extend in the x-axis direction and are provided at regular intervals in the z-axis direction. The support parts 14 are supported by the support columns 11. In the support column 11 provided on the most y-axis positive direction side, the support part 14 is provided on the y-axis negative direction side of the support column 11. In the support column 11 provided on the most y-axis negative direction side, the support part 14 is provided on the y-axis positive direction side of the support column 11. In each of the support columns 11 other than the above ones, the support part 14 is provided on the y-axis positive direction side and the y-axis negative direction side of the support column 11. A protrusion part 51 that protrudes from a container 50 outward in the width direction is supported by a pair of the support parts 14 opposed to each other in the y-axis direction. Therefore, the container 50 is incorporated into a storage section including the pair of the support parts 14 opposed to each other.

The pair of the support parts 14 opposed to each other in the y-axis direction may support a bottom surface of the container 50. The shelf 10a may support the container 50 by a shelf plate installed parallel to the xy-plane.

The support parts 14 may be configured so that they are fixed to the support columns 11 through slide rails and can be pulled out. The slide rails may be composed of an outer rail fastened and fixed to the support column 11, an intermediate rail supported by the outer rail in such a manner that it can be pulled out, and an inner rail supported by the intermediate rail in such a manner that it can be pulled out. The inner rail is fastened and fixed to the support parts 14, and the support parts 14 are supported by the support columns 11. When the support parts 14 are pulled out, the container 50 supported by the support parts 14 is pulled out. Note that the first embodiment may also include a case where the shelf 10a does not include a drawer. For example, the support parts 14 may be fixed to the support columns 11, and the protrusion part 51 of the container 50 may slide on the support parts 14. A front plate installed parallel to the yz plane may be attached to end parts of the support parts 14 on the x-axis positive direction side. The front plate may include a handle held by a user.

Referring to FIG. 2, the conveyance part 20 is provided between the shelf 10a and the shelf 10b. The conveyance part 20 includes a slide rail 21 installed parallel to the y-axis, a slide rail 22 installed parallel to the z-axis, and a holding part 23. As the slide rail 22 moves along the slide rail 21 and the holding part 23 moves along the slide rail 22, the holding part 23 moves in the y-axis direction and the z-axis direction. The holding part 23 includes, for example, a top plate on which the container 50 can be placed and an arm. The arm pushes the container 50 placed on the holding part 23, i.e., the top plate, into the shelf 10 and pulls the container 50 housed in the shelf 10 out onto the holding part 23. For example, an end effector provided at the tip of the arm is engaged with (e.g., grasps or sticks to) a surface (e.g., a bottom surface) of the container 50 on the holding part 23, and the arm is extended in the x-axis direction, whereby the container 50 is housed in the shelf 10. Further, as the end effector provided at the tip of the arm is engaged with the container 50 housed in the shelf 10 and the arm is contracted in the x-axis direction, the container 50 is placed on the holding part 23. When the container 50 is put into and taken out of the shelf 10a, the arm of the holding part 23 may be extended toward the x-axis positive direction side from the top plate, while when the container 50 is put into and taken out of the shelf 10b, the arm of the holding part 23 may be extended toward the x-axis negative direction side from the top plate. Note that the arm and the end effector may be provided in the shelf 10.

The conveyance part 20 can transfer the container 50 among a plurality of storage sections of the shelf 10a. Similarly, the conveyance part 20 can transfer the container 50 among a plurality of storage sections of the shelf 10b. Further, the conveyance part 20 can transfer the container 50 among the storage sections of the shelf 10a and the storage sections of the shelf 10b. The conveyance part 20 is not limited to being composed of an orthogonal robot, and may instead be composed of an articulated robot.

Like the conveyance part 20, the camera 30 is provided between the shelf 10a and the shelf 10b. The camera 30 is attached to an upper end of the slide rail 22 in a downward direction. The camera 30 captures a captured image of the interior of the container 50 placed on the holding part 23. The camera 30 may capture a captured image of the container 50 after the conveyance part 20 brings the container 50 placed on the holding part 23 sufficiently close to the camera 30. Note that the position to which the camera 30 is attached is not limited to the upper end of the slide rail 22. When the camera 30 is not attached to the slide rail 22, the camera 30 may capture a captured image of the container 50 after the holding part 23 moves in the y-axis direction. Further, the camera 30 may be provided in a predetermined storage section of the shelf 10 or in each storage section of the shelf 10.

Referring to FIG. 3, the storage system 100 is connected to a user terminal 200 used by a user U through a wire or wirelessly. The user terminal 200 is not limited to any particular apparatus as long as it can communicate with the storage system 100, and may be, for example, a mobile communication terminal such as a smartphone or a tablet terminal, or a Personal Computer (PC) installed indoors. Note that the user terminal 200 may be an operation panel (e.g., a touch panel) attached to the shelf 10.

The storage system 100 includes the control apparatus 40. The control apparatus 40 includes, as components that are not shown, an arithmetic unit such as a Central Processing Unit (CPU), and a storage unit such as a Random Access Memory (RAM) and a Read Only Memory (ROM) in which various types of control programs, data, and the like are stored. The control apparatus 40 is connected to the shelf 10, the conveyance part 20, and the camera 30 so that they can communicate with each other. The functions of the control apparatus 40 may be provided in, for example, a control apparatus which controls the conveyance part 20 and a control apparatus which controls the camera 30. Further, the functions of the control apparatus 40 may be provided in a computer apparatus such as a server. The control apparatus 40 includes a conveyance control unit 41, a marker recognition unit 42, a generation unit 43, a search unit 44, and a management unit 45.

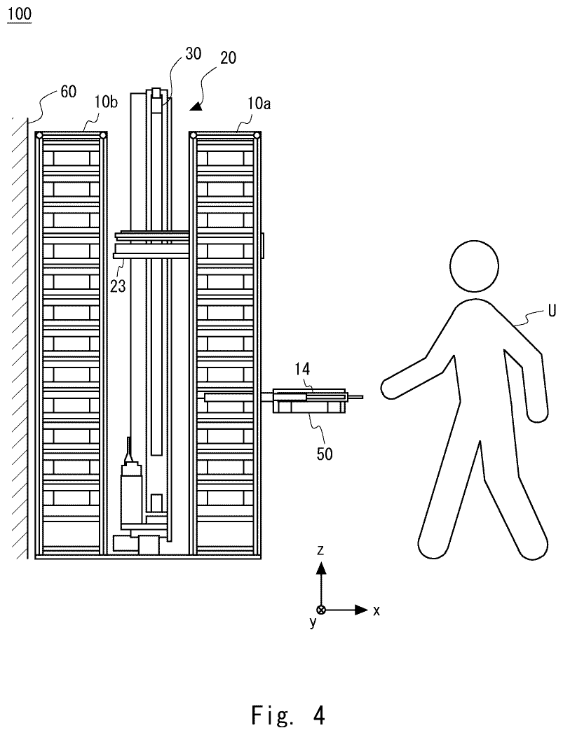

FIG. 4 is a schematic side view of the storage system 100. The user U stores items in the container 50 housed in the shelf 10a and takes the items out of the container 50 housed in the shelf 10a. Since the opening of the shelf 10b on the x-axis negative direction side faces a wall 60 of the residence, the user U cannot store items in and take them out of the container 50 housed in the shelf 10b. The items may be, for example, clothes, cosmetics, toys, tableware, or cutlery.

Since the conveyance part 20 operates between the shelf 10a and the shelf 10b, the storage system 100 can ensure the safety of the user U.

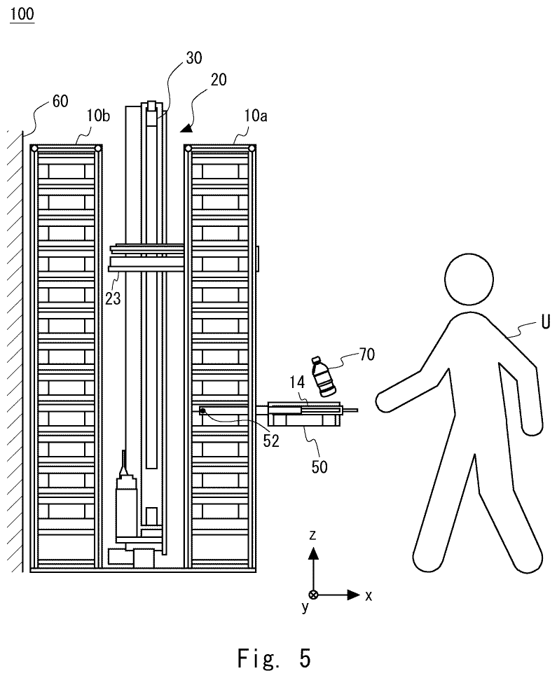

FIG. 5 is a schematic diagram illustrating an operation of the storage system 100 according to the first embodiment. The shelf 10a includes a sensor 52 which is provided at an end part of the shelf 10a on the x-axis negative direction side and which detects the container 50. For example, the sensor 52 may be a limit switch pressed by the container 50. The sensor 52 may be fixed to the support column 11. When the user U pulls out the container 50, the sensor 52 transmits a signal indicating that the container 50 is pulled out to the conveyance control unit 41 of the control apparatus 40. When the user U stores an item 70 in the container 50 and pushes the container 50 into the shelf 10a, the sensor 52 transmits a signal indicating that the container 50 is pushed into to the conveyance control unit 41. The conveyance control unit 41 instructs the conveyance part 20 to pull out the container 50 onto the holding part 23 and move the holding part 23 in the z-axis positive direction. When the camera 30 captures a captured image of the container 50, the conveyance control unit 41 instructs the conveyance part 20 to push the container 50 into the original storage section or another storage section.

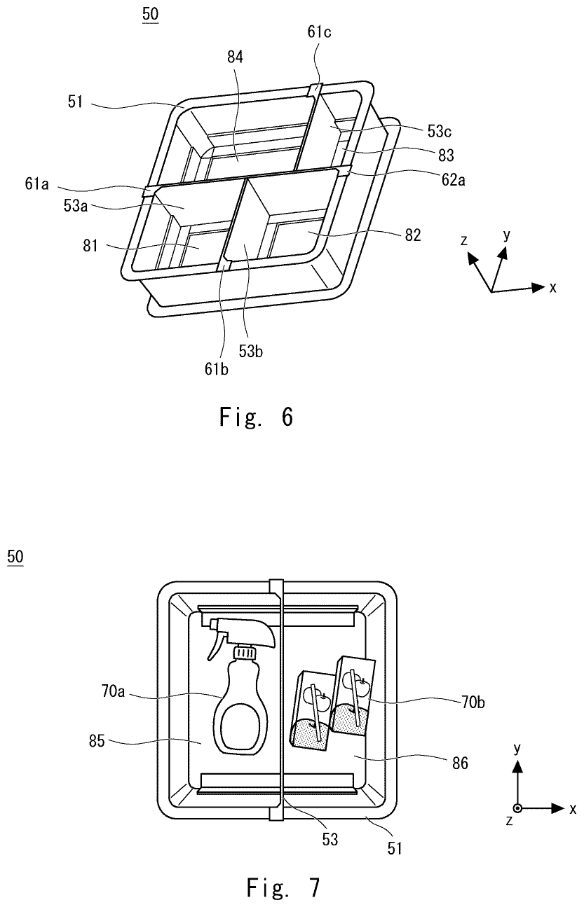

FIG. 6 is a perspective view illustrating the container 50 according to the first embodiment. The container 50 includes separators 53a to 53c. The separators 53a to 53c separate the interior of the container 50 into a plurality of storage areas 81 to 84. Each of the separators 53a to 53c may be simply referred to as a separator 53 when they are not distinguished from each other. The separator 53 includes a plate-like member installed parallel to the xz plane or the yz plane. The height of the separator 53, that is, the length thereof in the z-axis direction, may coincide with the depth of the interior of the container 50.

Tabs 61a and 62a parallel to the xy plane are provided at respective ends of the plate-like member of the separator 53a. The separator 53 may be regarded as a separator in which a separator including the tab 61a and a separator including the tab 62a are integrated with each other. A tab 61b parallel to the xy plane is provided at one end of the plate-like member of the separator 53b. A tab 61c parallel to the xy plane is provided at one end of the separator 53c. Each of the tabs 61a, 62a, 61b, and 61c may be simply referred to as a tab 6 when they are not distinguished from each other.

The tab 6 includes a visual marker. The visual marker is a unique two-dimensional code for identifying the tab 6 or the separator 53. The marker recognition unit 42 of the control apparatus 40 recognizes the storage areas 81 to 84 in the container 50 by recognizing the image of the visual marker from the captured image of the container 50. Since the storage system 100 can recognize that the tab 6 is disposed at the position where the visual marker is detected, it can recognize how the interior of the container 50 is separated. The marker recognition unit 42 adds identification information to the recognized storage areas 81 to 84. For example, the marker recognition unit 42 may identify the storage areas 81, 82, 83, and 84 by the identification information of the tab 61a, the tab 61b, the tab 62a, and the tab 61c, respectively. The marker recognition unit 42 may identify each of the storage areas by any identification information other than the identification information of the tab 6.

Further, the protrusion part 51 of the container 50 may include a visual marker. The visual marker is a unique two-dimensional code for identifying the container 50. The marker recognition unit 42 may recognize the positional relation between the container 50 and the separator 53 based on the visual marker of the protrusion part 51 of the container 50.

Items of the same type are stored in the respective storage areas separated by the separator 53. FIG. 7 is a schematic diagram illustrating items 70a and 70b stored in the container 50. Storage areas 85 and 86 separated by the separator 53 respectively store the item 70a, which is a detergent, and the items 70b, which are two beverages.

Note that a plurality of items of the same type may have attributes different from each other. For example, the storage system 100 may use a blue paint marker, a yellow paint marker, and a green paint marker as items of the same type.

Note that the first embodiment may also include a case where the separator 53 is not disposed in the container 50. When the visual marker of the separator 53 is not recognized, the marker recognition unit 42 recognizes that the interior of the container 50 is not separated, and regards the interior of the container 50 as one storage area. The marker recognition unit 42 may identify one storage area by the visual marker of the protrusion part 51 of the container 50.

Referring to FIG. 3, the generation unit 43 acquires captured images captured by the camera 30, and generates an inventory of a plurality of items stored in a plurality of the containers 50 based on the captured images. The generation unit 43 may control the camera 30 to acquire the captured images. The inventory may include identification information of the items and text information (also referred to as item information) extracted from image areas of the items. The image areas of the items are included in the captured images. The item information may be associated with identification information of the storage area that stores the item. Specifically, the generation unit 43 generates the item information by using a Vision Language Model (VLM). The VLM may include, for example, a function of extracting features from an image, Large Language Models (LLM), and a function of converting the features extracted from the image into information that can be handled by the LLM. The item information may be further associated with the image area of the item included in the captured image.

Further, the generation unit 43 generates information indicating into which storage section the container 50 including a storage area that stores the item, i.e., the container that stores the item, is incorporated. The information indicating the storage section of the container 50 includes, for example, information indicating the number of storage sections located on the z-axis positive direction side of the subject storage section and information indicating the number of storage sections located on the y-axis negative direction side of the subject storage section. The item information is associated with the storage area in the container 50 and the storage section into which the container 50 is incorporated. When the container 50 has been conveyed by the conveyance part 20, the generation unit 43 updates the information about the storage section associated with the information of the item stored in the container 50.

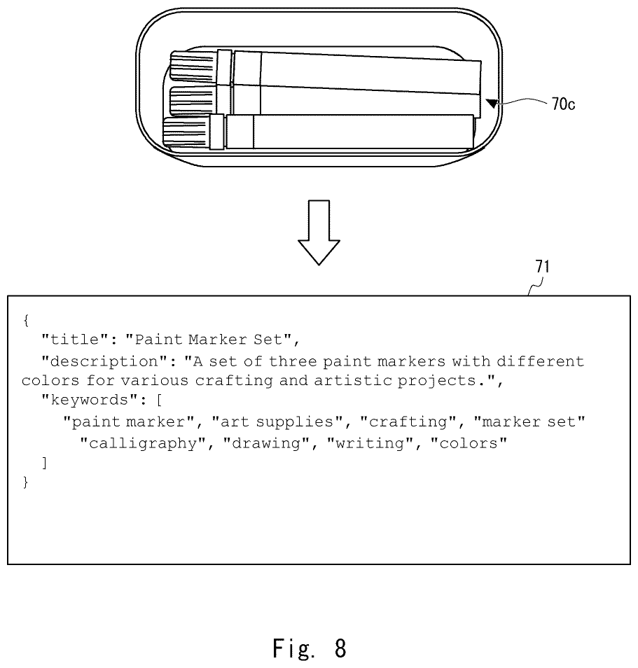

FIG. 8 is a schematic diagram illustrating item information. In FIG. 8, a code 71 shown under the arrow illustrates item information of an item 70c shown above the arrow. The item 70c is a set of blue, green, and yellow paint markers. The code 71 includes a title, a description, and keywords. The title indicates the type of the item 70c (e.g., paint marker set). The description indicates that it is a set of three paint markers with different colors for various crafting and artistic projects. The keywords include “paint marker”, “art supplies”, “crafting”, “marker set”, “calligraphy”, “drawing”, “writing”, and “colors”.

Referring to FIG. 3, the search unit 44 searches for an item corresponding to text information input by the user U to the user terminal 200 based on the inventory. As described above, since the item is associated with storage section of the container 50 storing this item, it can be said that the search unit 44 searches for the container 50 storing the item. Specifically, the search unit 44 searches for item information having a high degree of relation with text information input by the user U among a plurality of pieces of item information included in the inventory.

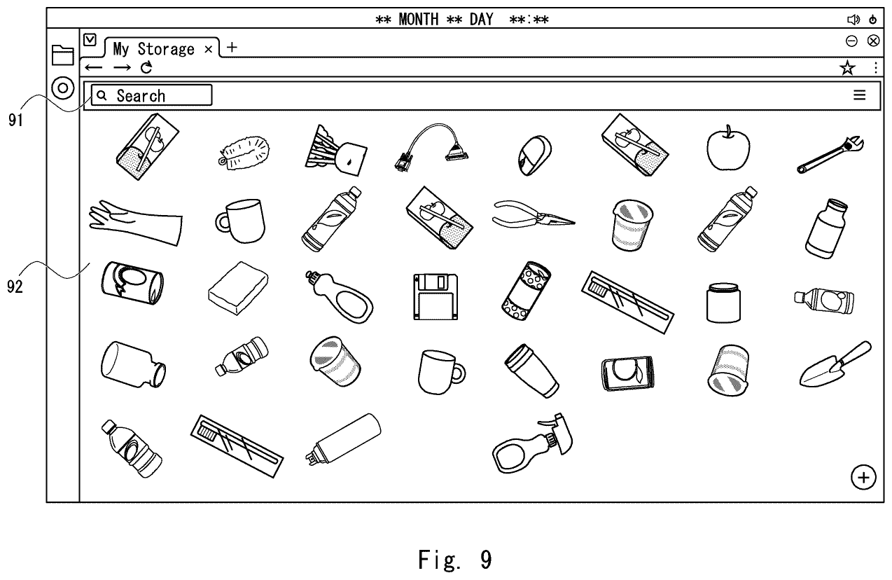

FIG. 9 is a schematic diagram illustrating a display screen displayed on the user terminal 200. The display screen includes a search bar 91 and a display area 92. First, images of all items stored in the shelf 10 are displayed on the display area 92. The user U inputs text information indicating the item to be taken out of the shelf 10 into the search bar 91. Then, the search unit 44 displays images of one or more items corresponding to the text information on the display area 92.

When the user U takes the item displayed on the display area 92 out of the shelf 10, the user U performs an operation for selecting an image of the item displayed on the display area 92. Then, the search unit 44 determines whether or not the container 50 needs to be transferred. When the user U cannot easily access the storage section into which the container 50 is incorporated, the search unit 44 determines that the container 50 needs to be transferred. The storage section (also referred to as a first storage section) which cannot be easily accessed by the user U includes at least one of the storage section of the shelf 10b, the storage section provided at a position higher than a threshold in the shelf 10a, and the storage section provided at a position lower than a threshold in the shelf 10a. When the container 50 is transferred, the search unit 44 instructs the conveyance part 20 to transfer the container 50 to the storage section (also referred to as a second storage section) that can be more easily accessed by the user than the first storage section. When the second storage section is not available, the search unit 44 may transfer any container housed in the second storage section to the first storage section in advance. When the container 50 has been transferred, the generation unit 43 updates information about the storage section associated with the item stored in the container 50 as described above.

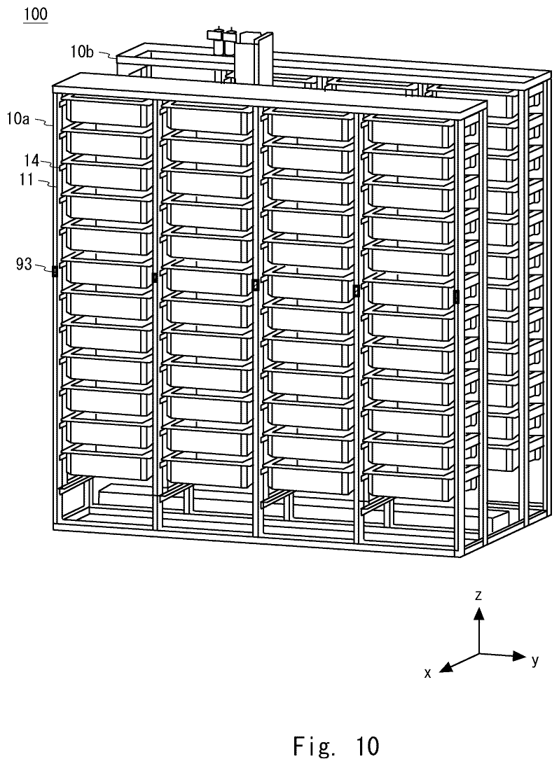

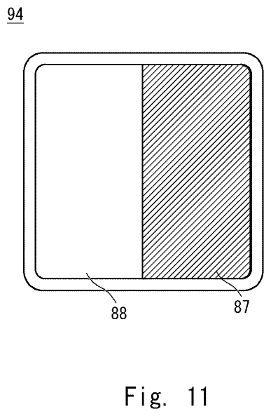

The search unit 44 presents the storage section into which the container 50 in which the item is stored is incorporated to the user U. For example, the search unit 44 turns on a light emitting unit(s) 93 provided near the storage section into which the container 50 is incorporated. The light emitting units 93 are, for example, Light Emitting Diodes (LEDs). FIG. 10 is a schematic view illustrating the shelf 10a to which the light emitting units 93 are attached. The light emitting units 93 are attached to the support columns 11 of the shelf 10a. The search unit 44 turns on, for example, at least one of two light emitting units 93 located on respective sides of the searched container 50. When the support parts 14 that support the container 50 are configured so that they can be pulled out, the light emitting unit 93 may be attached to the front plate of a drawer.

Further, the search unit 44 presents information about the storage area in which the selected item is stored. For example, the search unit 44 may highlight the storage area in which the searched item is stored in a container image showing the interior of the container 50, and display the container image on the display unit of the user terminal 200. FIG. 11 is a schematic diagram illustrating an image 94 displayed on the display unit of the user terminal 200. The image 94 shows storage areas 87 and 88 in the container 50. The image 94 may be an image captured by the camera 30 or an illustration. In the image 94, the storage area 87 that stores the item searched for by the user U is highlighted.

Referring to FIG. 3, the management unit 45 records the frequency of use of each of the items stored in the shelf 10. The frequency of use of the item may be calculated based on at least one of an operation performed on the user terminal 200 and a result of detection by the sensor 52. The operation performed on the user terminal 200 may be an operation for taking out the item (e.g., an operation for selecting an image of the item to be taken out). The management unit 45 instructs the conveyance part 20 to transfer the container 50 storing the item whose frequency of use is higher than a threshold to the second storage section. Similarly, the management unit 45 instructs the conveyance part 20 to transfer the container 50 storing the item whose frequency of use is lower than a threshold to the first storage section.

The storage system 100 according to the first embodiment can facilitate the management of items stored in the shelf 10.

The user U can easily search for the items stored in the shelf 10 using a natural language. Therefore, the mental burden of searching for items on the user U can be reduced.

Since the conveyance part 20 can access the upper part of the shelf 10a and the shelf 10b, which cannot be easily accessed by the user U, the storage system 100 can improve the efficiency of storing items.

Items of the same type are stored in the respective storage area in the container 50, whereby the storage system 100 can avoid recognizing images of a plurality of types of items, for example, recognizing images of a plurality of types of items stacked on top of each other.

Since the capturing of captured images of the container 50 and the transfer of the container 50 do not require the supervision of the user U, these processes can be performed, for example, after the user U leaves the area near the storage system 100. The storage system 100 can prevent an increase in the time required to store items.

Note that the present disclosure is not limited to the above-described embodiments and may be changed as appropriate without departing from the scope and spirit of the present disclosure. Further, the present disclosure may be implemented by causing a processor such as a Central Processing Unit (CPU) to execute a computer program for all or part of processing performed in the control apparatus 40. For example, the control apparatus 40 may be implemented as an apparatus capable of executing a program, such as a central processing unit of a computer. Further, various functions may be implemented by the program.

The above-described program includes instructions (or software codes) that, when loaded into a computer, cause the computer to perform one or more of the functions. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and a magnetic cassette, a magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Note that the present disclosure is not limited to the above-described embodiments and may be changed as appropriate without departing from the scope and spirit of the present disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A storage system comprising:
a shelf including a plurality of storage sections into which a plurality of respective containers are able to be incorporated;
a camera configured to capture a captured image of each of the containers;
a conveyance part configured to convey each of the containers among the plurality of storage sections;
a generation unit configured to generate an inventory of a plurality of items stored in the plurality of the containers based on the captured images; and
a search unit configured to search for the container in which the item corresponding to text information input by a user is stored based on the inventory.

2. The storage system according to claim 1, wherein
the storage system comprises separators configured to separate interiors of the respective containers into a plurality of storage area,
a marker is provided in each of the separators,
each of the storage areas is recognized based on the marker in the captured image,
the inventory indicates an item stored in each of the storage areas, and
the search unit searches for the storage area in which the item is stored, and presents information indicating the searched storage area to the user.

3. The storage system according to claim 2, wherein items of the same type are stored in each of the storage areas.

4. The storage system according to claim 2, wherein the search unit highlights the searched storage area in a container image, and presents the container image to the user.

5. The storage system according to claim 1, wherein
the plurality of storage sections include a first storage section, and a second storage section that can be more easily accessed by a user than the first storage section, and
when the searched container is incorporated into the first storage section, the conveyance part conveys the searched container to the second storage section.

6. The storage system according to claim 5, wherein the camera and the conveyance part are disposed between a first shelf including the first storage section and a second shelf including the second storage section.

7. The storage system according to claim 1, further comprising a light emitting unit provided near each of the storage sections,
wherein the search unit turns on the light emitting unit near the storage section into which the searched container is incorporated.

8. The storage system according to claim 1, wherein the generation unit generates text information about each of the items from the captured images by using a Vision Language Model (VLM), and generates the inventory including the generated text information.
